(19) United States
(12) Patent Application Publication
(10) Pub. No.: US 2008/0001782 A1
(43) Pub. Date: Jan. 3, 2008

(54) AIRFIELD LIGHTING SYSTEM AND METHOD

(75) Inventor: Daniel A. That, South Windsor, CT (US)

Correspondence Address: Todd Mattingly;King & Spalding LLP, Suite 4000, 1100 Louisiana, Houston, TX, 77002, US

(73) Assignee: Cooper Technologies Company, Houston, TX (US)

(21) Appl. No.: 11/610,141

(22) Filed: Dec. 13, 2006

Related U.S. Application Data
(60) Provisional application No. 60/806,406, filed on Jun. 30, 2006.
(60) Provisional application No. 60/806,408, filed on Jun. 30, 2006.

(51) Int. Cl. G08G 5/00

(52) U.S. Cl. 340/947

(57) ABSTRACT

An airfield lighting system is described.

### CROSS-REFERENCE TO RELATED APPLICATIONS

The present application is related to the following co-pending applications: U.S. provisional patent application No. 60/806,406, attorney docket no. 23667.532, filed on Jun. 30, 2006; U.S. provisional patent application No. 60/806,408, attorney docket no. 23667.533, filed on Jun. 30, 2006; and U.S. utility patent application Ser. No. ______, attorney docket no. 23667.499, filed on ______.

### BACKGROUND

The present disclosure relates in general to lighting systems, and in particular to airfield lighting systems.

### BRIEF DESCRIPTION OF THE DRAWINGS

FIG. 1 is a diagrammatic view of an airfield lighting system according to an exemplary embodiment, the airfield lighting system including a lighting fixture.

FIG. 2 is a diagrammatic view of an airfield lighting system according to another exemplary embodiment, the airfield lighting system including a lighting fixture.

FIG. 3A is a diagrammatic view of the lighting fixture of FIG. 1 or 2 according to an exemplary embodiment.

FIG. 3B is a diagrammatic view of the lighting fixture of FIG. 1 or 2 according to another exemplary embodiment.

FIG. 3C is a diagrammatic view of the lighting fixture of FIG. 1 or 2 according to yet another exemplary embodiment.

### DETAILED DESCRIPTION

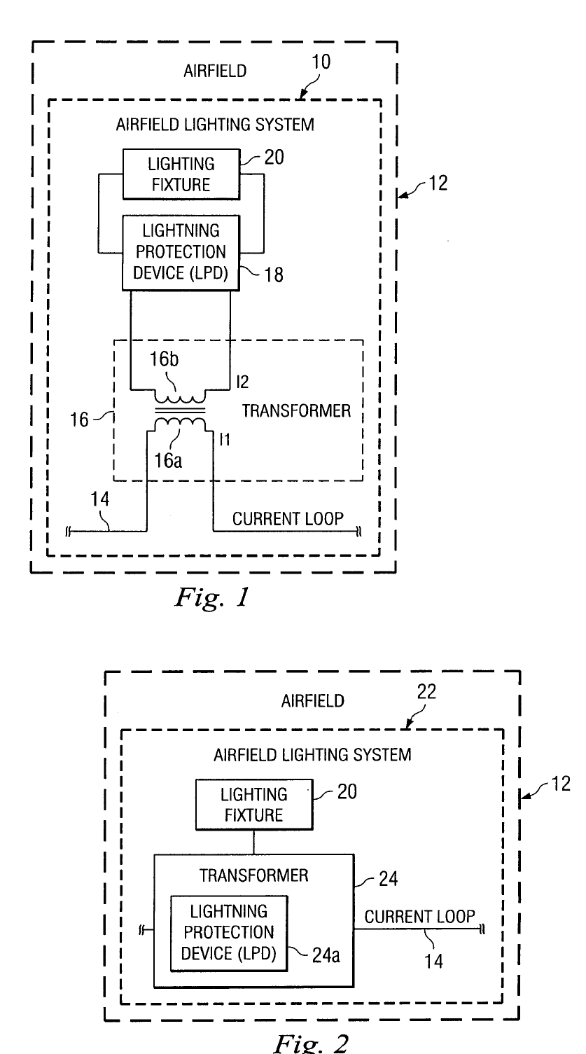

In an exemplary embodiment, as illustrated in FIG. 1, an airfield lighting system is generally referred to by the reference numeral 10 and is positioned in an airfield 12. The airfield lighting system 10 includes a main series current loop 14 and an isolation transformer 16 electrically coupled thereto. The isolation transformer 16 includes a primary coil 16a and a secondary coil 16b. In an exemplary embodiment, the isolation transformer 16 is a constant-current transformer. In an exemplary embodiment, the isolation transformer 16 is an AC-to-DC transformer, an AC-to-AC transformer or any combination thereof.

A lightning protection device 18 is electrically coupled to the output of the secondary coil 16b of the isolation transformer 16, and a lighting fixture 20 is electrically coupled to the lightning protection device 18. As a result, electrical power is adapted to be supplied to the lighting fixture 20 via the isolation transformer 16 and the lightning protection device 18. The lightning protection device 18 is adapted to protect the lighting fixture 20 from power surges produced by lightning strikes, as will be described in further detail below. The lightning protection device 18 is properly sized to protect the lighting fixture 20. In several exemplary embodiments, the lightning protection device 18 includes one or more conventional, commercially-available lightning protection devices.

In several exemplary embodiments, the airfield 12 includes one or more taxiways, one or more runways and/or any combination thereof. In several exemplary embodiments, the airfield lighting system 10 is adapted to provide light to one or more areas of the airfield 12 such as, for example, one or more taxiways, one or more runways and/or any combination thereof. In several exemplary embodiments, the airfield lighting system 10 includes one or more additional lighting fixtures 20 electrically coupled to the current loop 14, and one or more additional isolation transformers 16 and lightning protection devices 18 electrically coupled between the one or more additional lighting fixtures 20, respectively, and the current loop 14. In several exemplary embodiments, the airfield lighting system 10 includes one or more additional current loops 14.

In operation, in an exemplary embodiment, the airfield lighting system 10 provides light to one or more portions of the airfield 12. In several exemplary embodiments, the airfield lighting system 10 provides light to one or more taxiways of the airfield 12 or portions thereof, one or more runways of the airfield 12 or portions thereof, one or more other portions of the airfield 12, and/or any combination thereof.

During operation, in an exemplary embodiment, electrical power is supplied to the current loop 14 in a conventional manner so that a current I1 flows through the primary coil 16a of the isolation transformer 16. The isolation transformer 16 operates to output electrical power so that a current I2 flows through the secondary coil 16b. Electrical power is transferred from the isolation transformer 16 to the lightning protection device 18, which, in turn, transfers electrical power to the lighting fixture 20. In response to this supply of electrical power, the lighting fixture 20 provides light to at least a portion of the airfield 12.

In an exemplary embodiment, the isolation transformer 16 is an AC-to-DC transformer, an AC power supply is electrically coupled to the current loop 14 so that AC electrical power is supplied to the current loop 14, and the isolation transformer 16 operates to output DC electrical power. In an exemplary embodiment, the isolation transformer 16 is an AC-to-DC transformer that includes a full-bridge rectifier to achieve the conversion to DC electrical power. In an exemplary embodiment, the isolation transformer 16 is an AC-to-DC transformer that includes a half-bridge rectifier to achieve the conversion to DC electrical power. In an exemplary embodiment, the isolation transformer 16 is an AC-to-DC transformer that includes a full-bridge rectifier, a half-bridge rectifier, and/or any combination thereof, to achieve the conversion to DC electrical power, and further includes a capacitor to smooth out the waveform.

During operation, in an exemplary embodiment, if the lighting fixture 20 fails, the isolation transformer 16 operates to protect the current loop 14 from opening, thereby permitting electrical power to be continued to be supplied, via the current loop 14, to any other components, devices or systems electrically coupled to the current loop 14, notwithstanding the failure of the lighting fixture 20.

During operation, in an exemplary embodiment, if one or more lightning strikes occur in the airfield lighting system 10, one or more power surges may be produced in the current loop 14 and/or the transformer 16. If one or more power surges in the current loop 14 and/or the transformer 16 are produced in response to the occurrence of one or more lightning strikes, the lightning protection device 18 operates to withstand the power surges, preventing the power surges from reaching the lighting fixture 20. As a result, notwithstanding the occurrence of lightning strikes, the lighting fixture 20 remains operational and failure of the lighting fixture 20 is avoided. As a result, the risk of failure in the airfield lighting system 10 is reduced. Moreover, the risk of a full-system shutdown of the airfield lighting system 10 is reduced.

In an exemplary embodiment, the lighting fixture 20 includes a lamp and, as a result of the lighting protection device 18 preventing the power surges produced by the lightning strikes from reaching the lighting fixture 20, the failure of the lighting fixture 20, in the form of a lamp blowout, is avoided. In an exemplary embodiment, the lighting fixture 20 includes a circuit and, as a result of the lightning protection device 18 preventing the power surges produced by the lightning strikes from reaching the lighting fixture 20, the failure of the lighting fixture 20, in the form of a circuit failure, is avoided.

In several exemplary embodiments, the airfield lighting system 10 includes additional circuitry to which electrical power is supplied from the output of the isolation transformer 16; the lightning protection device 18 is electrically coupled between the secondary coil 16b of the isolation transformer 16 and the additional circuitry in the airfield lighting system 10, and operates to protect the additional circuitry from any power surges produced as a result of lighting strikes.

In an exemplary embodiment, as illustrated in FIG. 2, an airfield lighting system is generally referred to by the reference numeral 22 and includes parts of the airfield lighting system 10, which are given the same reference numerals. The airfield lighting system 22 is positioned in the airfield 12 and includes an isolation transformer 24 that is electrically coupled to the main series current loop 14. The isolation transformer 24 includes a lightning protection device 24a electrically coupled thereto and disposed therein. In an exemplary embodiment, the lightning protection device 24a is molded inside the isolation transformer 24. The lighting fixture 20 is electrically coupled to the isolation transformer 24 and thus is electrically coupled to the lightning protection device 24a inside the isolation transformer 24. Since the lightning protection device 24a is inside the isolation transformer 24, there are less components to manage and manipulate during the installation of the airfield lighting system 22. As result, the installation of the airfield lighting system 22 is faster and easier.

In operation, in an exemplary embodiment, the lightning protection device 24a of the isolation transformer 24 protects the lighting fixture 20 from power surges produced by lighting strikes in the airfield lighting system 22, thereby permitting the lighting fixture 20 to remain operational, notwithstanding the occurrence of lightning strikes. The operation of the airfield lighting system 22 is substantially similar to the above-described operation of the airfield lighting system 10 and therefore the operation of the airfield lighting system 22 will not be described in further detail.

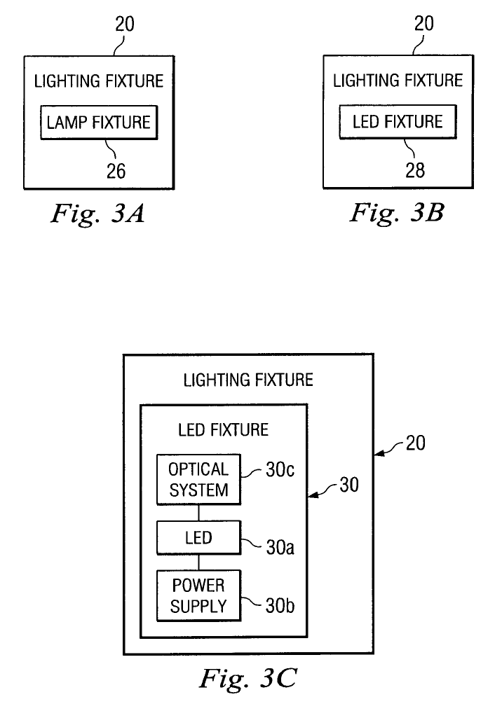

In an exemplary embodiment, as illustrated in FIG. 3A, the lighting fixture 20 includes a lamp fixture 26.

In an exemplary embodiment, as illustrated in FIG. 3B, the lighting fixture 20 includes a light-emitting diode (LED) fixture 28.

In an exemplary embodiment, as illustrated in FIG. 3C, the lighting fixture 20 includes an LED fixture 30 including at least one LED 30a, a power supply 30b electrically coupled to the LED 30a, and an optical system 30c operably coupled to the LED 30a. In an exemplary embodiment, the LED 30a includes a single high-intensity LED. In an exemplary embodiment, the LED 30a includes an array of multiple high-intensity LEDs. In an exemplary embodiment, the power supply 30b includes one or more power supplies. In an exemplary embodiment, the optical system 30c includes one or more lenses. In an exemplary embodiment, the optical system 30c includes one or more reflectors. In an exemplary embodiment, the optical system 30c includes a single high-efficiency lens, a plurality of high-efficiency lenses, a single reflector, a plurality of reflectors, and/or any combination thereof.

In an exemplary embodiment, during the above-described operation of the airfield lighting system 10 or 22, and in response to the supply of electrical power to the lighting fixture 20, the power supply 30b drives the LED 30a, providing the required current and voltage to the LED 30a. In an exemplary embodiment, the power supply 30b compensates for temperature, facilitates the meeting of intensity curve matching, and provides surge protection. In an exemplary embodiment, the power supply 30b is configured so that the provision of current and voltage to the LED 30a meets one or more Federal Aviation Administration (FAA) specifications. In response to being driven by the power supply 30b, the LED 30a emits light. The optical system 30c collimates and spreads the light emitted by the LED 30a, thereby producing a photometric pattern. In an exemplary embodiment, the optical system 30c is configured to produce a photometric pattern that meets one or more FAA specifications.

An airfield lighting system has been described that includes a transformer; a lighting fixture electrically coupled to the transformer; and a lightning protection device electrically coupled between the transformer and the lighting fixture. In an exemplary embodiment, the lightning protection device is configured to withstand a power surge produced by a lightning strike and thereby protect the lighting fixture from the power surge produced by the lightning strike. In an exemplary embodiment, the lighting fixture is adapted to be positioned in an airfield so that the lighting fixture is adapted to provide light to at least a portion of the airfield. In an exemplary embodiment, the transformer comprises an isolation transformer. In an exemplary embodiment, the airfield lighting system comprises a current loop to which the isolation transformer is electrically coupled; wherein the isolation transformer is adapted to protect the current loop from opening if the lighting fixture fails. In an exemplary embodiment, the lightning protection device is inside the transformer. In an exemplary embodiment, the lighting fixture comprises a lamp fixture. In an exemplary embodiment, the lighting fixture comprises an LED fixture. In an exemplary embodiment, the LED fixture comprises at least one LED; at least one power supply electrically coupled to the at least one LED; and an optical system operably coupled to the at least one LED.

A method has been described that includes providing light to at least a portion of an airfield using a lighting fixture; and if a lightning strike occurs and a power surge is produced by the lightning strike, then protecting the lighting fixture from the power surge produced by the lightning strike, comprising electrically coupling a transformer to the lighting fixture; and electrically coupling a lightning protection device between the transformer and the lighting fixture. In an exemplary embodiment, the lightning protection device is inside the transformer. In an exemplary embodiment, providing light to the at least a portion of the airfield using the lighting fixture comprises supplying electrical power to the lighting fixture. In an exemplary embodiment, supplying electrical power to the lighting fixture comprises supplying electrical power to the transformer; and supplying electrical power to the lighting fixture in response to supplying electrical power to the transformer. In an exemplary embodiment, supplying electrical power to the lighting fixture comprises electrically coupling a current loop to the lighting fixture. In an exemplary embodiment, the method comprises if the lighting fixture fails, then preventing the current loop from opening in response to the failure of the lighting fixture. In an exemplary embodiment, the lighting fixture comprises a lamp fixture. In an exemplary embodiment, the lighting fixture comprises an LED fixture. In an exemplary embodiment, the LED fixture comprises at least one LED; at least one power supply electrically coupled to the at least one LED; and an optical system operably coupled to the at least one LED.

An airfield lighting system adapted to be at least partially positioned in an airfield has been described that includes a transformer, comprising an isolation transformer; a lightning protection device disposed inside the transformer and electrically coupled to the isolation transformer; a lighting fixture electrically coupled to the lightning protection device, the lighting fixture adapted to be positioned in the airfield and provide light to at least a portion of the airfield; and a current loop to which the isolation transformer is electrically coupled; wherein the isolation transformer is adapted to protect the current loop from opening if the lighting fixture fails; wherein the lightning protection device is configured to withstand a power surge produced by a lightning strike and thereby protect the lighting fixture from the power surge produced by the lightning strike; and wherein the lighting fixture comprises an LED fixture comprising at least one LED; at least one power supply electrically coupled to the at least one LED; and an optical system operably coupled to the at least one LED.

A system has been described that includes means for providing light to at least a portion of an airfield using a lighting fixture; and means for if a lightning strike occurs and a power surge is produced by the lightning strike, then protecting the lighting fixture from the power surge produced by the lightning strike, comprising means for electrically coupling a transformer to the lighting fixture; and means for electrically coupling a lightning protection device between the transformer and the lighting fixture. In an exemplary embodiment, the lightning protection device is inside the transformer. In an exemplary embodiment, means for providing light to the at least a portion of the airfield using the lighting fixture comprises means for supplying electrical power to the lighting fixture. In an exemplary embodiment, means for supplying electrical power to the lighting fixture comprises means for supplying electrical power to the transformer; and means for supplying electrical power to the lighting fixture in response to supplying electrical power to the transformer. In an exemplary embodiment, means for supplying electrical power to the lighting fixture comprises means for electrically coupling a current loop to the lighting fixture. In an exemplary embodiment, the system comprises means for if the lighting fixture fails, then preventing the current loop from opening in response to the failure of the lighting fixture. In an exemplary embodiment, the lighting fixture comprises a lamp fixture. In an exemplary embodiment, the lighting fixture comprises an LED fixture. In an exemplary embodiment, the LED fixture comprises at least one LED; at least one power supply electrically coupled to the at least one LED; and an optical system operably coupled to the at least one LED.

A method has been described that includes providing light to at least a portion of an airfield using a lighting fixture; and if a lightning strike occurs and a power surge is produced by the lightning strike, then protecting the lighting fixture from the power surge produced by the lightning strike, comprising electrically coupling a transformer to the lighting fixture; and electrically coupling a lightning protection device between the transformer and the lighting fixture; wherein providing light to the at least a portion of the airfield using the lighting fixture comprises supplying electrical power to the lighting fixture, comprising electrically coupling a current loop to the transformer; supplying electrical power to the transformer; and supplying electrical power to the lighting fixture in response to supplying electrical power to the transformer; wherein the method further comprises if the lighting fixture fails, then preventing the current loop from opening in response to the failure of the lighting fixture; and wherein the lighting fixture comprises an LED fixture, the LED fixture comprising at least one LED; at least one power supply electrically coupled to the at least one LED; and an optical system operably coupled to the at least one LED.

A system has been described that includes means for providing light to at least a portion of an airfield using a lighting fixture; and means for if a lightning strike occurs and a power surge is produced by the lightning strike, then protecting the lighting fixture from the power surge produced by the lightning strike, comprising means for electrically coupling a transformer to the lighting fixture; and means for electrically coupling a lightning protection device between the transformer and the lighting fixture; wherein means for providing light to the at least a portion of the airfield using the lighting fixture comprises means for supplying electrical power to the lighting fixture, comprising means for electrically coupling a current loop to the transformer; means for supplying electrical power to the transformer; and means for supplying electrical power to the lighting fixture in response to supplying electrical power to the transformer; wherein the system further comprises means for if the lighting fixture fails, then preventing the current loop from opening in response to the failure of the lighting fixture; and wherein the lighting fixture comprises an LED fixture, the LED fixture comprising at least one LED; at least one power supply electrically coupled to the at least one LED; and an optical system operably coupled to the at least one LED.

It is understood that variations may be made in the foregoing without departing from the scope of the disclosure. For example, in addition to, or instead of the airfield 12, the airfield lighting systems 10 and/or 22 may be used to provide light to other types of indoor and/or outdoor environments such as, for example, convention centers, exhibition halls, outdoor stadiums and/or any combination thereof.

Any spatial references such as, for example, “upper,” “lower,” “above,” “below,” “between,” “vertical,” “horizontal,” “angular,” “upward,” “downward,” “side-to-side,” “left-to-right,” “right-to-left,” “top-to-bottom,” “bottom-to-top,” “top,” “bottom,” etc., are for the purpose of illustration only and do not limit the specific orientation or location of the structure described above.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, the embodiments described are exemplary only and are not limiting, and those skilled in the art will readily appreciate that many other modifications, changes and/or substitutions are possible in the exemplary embodiments without materially departing from the novel teachings and advantages of the present disclosure. Accordingly, all such modifications, changes and/or substitutions are intended to be included within the scope of this disclosure as defined in the following claims. In the claims, means-plus-function clauses are intended to cover the structures described herein as performing the recited function and not only structural equivalents, but also equivalent structures.

What is claimed is:

1. An airfield lighting system comprising:
a transformer;
a lighting fixture electrically coupled to the transformer; and
a lightning protection device electrically coupled between the transformer and the lighting fixture.

2. A method comprising:
providing light to at least a portion of an airfield using a lighting fixture; and
if a lightning strike occurs and a power surge is produced by the lightning strike, then protecting the lighting fixture from the power surge produced by the lightning strike, comprising:
electrically coupling a transformer to the lighting fixture; and
electrically coupling a lightning protection device between the transformer and the lighting fixture.

3. An airfield lighting system adapted to be at least partially positioned in an airfield, the airfield lighting system comprising:
a transformer, comprising an isolation transformer;
a lightning protection device disposed inside the transformer and electrically coupled to the isolation transformer;
a lighting fixture electrically coupled to the lightning protection device, the lighting fixture adapted to be positioned in the airfield and provide light to at least a portion of the airfield; and
a current loop to which the isolation transformer is electrically coupled;
wherein the isolation transformer is adapted to protect the current loop from opening if the lighting fixture fails;
wherein the lightning protection device is configured to withstand a power surge produced by a lightning strike and thereby protect the lighting fixture from the power surge produced by the lightning strike; and
wherein the lighting fixture comprises:
an LED fixture comprising:
at least one LED;
at least one power supply electrically coupled to the at least one LED; and
an optical system operably coupled to the at least one LED.

4. A system comprising:
means for providing light to at least a portion of an airfield using a lighting fixture; and
means for if a lightning strike occurs and a power surge is produced by the lightning strike, then protecting the lighting fixture from the power surge produced by the lightning strike, comprising:
means for electrically coupling a transformer to the lighting fixture; and
means for electrically coupling a lightning protection device between the transformer and the lighting fixture.

5. A method comprising:
providing light to at least a portion of an airfield using a lighting fixture; and
if a lightning strike occurs and a power surge is produced by the lightning strike, then protecting the lighting fixture from the power surge produced by the lightning strike, comprising:
electrically coupling a transformer to the lighting fixture; and
electrically coupling a lightning protection device between the transformer and the lighting fixture;
wherein providing light to the at least a portion of the airfield using the lighting fixture comprises:
supplying electrical power to the lighting fixture, comprising:
electrically coupling a current loop to the transformer;
supplying electrical power to the transformer; and
supplying electrical power to the lighting fixture in response to supplying electrical power to the transformer;
wherein the method further comprises:
if the lighting fixture fails, then preventing the current loop from opening in response to the failure of the lighting fixture; and
wherein the lighting fixture comprises an LED fixture, the LED fixture comprising:
at least one LED;
at least one power supply electrically coupled to the at least one LED; and
an optical system operably coupled to the at least one LED.

6. A system comprising:
means for providing light to at least a portion of an airfield using a lighting fixture; and
means for if a lightning strike occurs and a power surge is produced by the lightning strike, then protecting the lighting fixture from the power surge produced by the lightning strike, comprising:
means for electrically coupling a transformer to the lighting fixture; and
means for electrically coupling a lightning protection device between the transformer and the lighting fixture;
wherein means for providing light to the at least a portion of the airfield using the lighting fixture comprises:
means for supplying electrical power to the lighting fixture, comprising:
means for electrically coupling a current loop to the transformer;
means for supplying electrical power to the transformer; and
means for supplying electrical power to the lighting fixture in response to supplying electrical power to the transformer;
wherein the system further comprises:
means for if the lighting fixture fails, then preventing the current loop from opening in response to the failure of the lighting fixture; and
wherein the lighting fixture comprises an LED fixture, the LED fixture comprising:
at least one LED;
at least one power supply electrically coupled to the at least one LED; and
an optical system operably coupled to the at least one LED.
